(19) United States
(12) Patent Application Publication
(10) Pub. No.: US 2012/0064297 A1
(43) Pub. Date: Mar. 15, 2012

(54) FINE PARTICLE FOR OPTICAL FUNCTION LAYER, OPTICAL MEMBER FOR DISPLAY, AND GLARE SHIELD FUNCTION LAYER

(75) Inventor: Makoto Honda, Tokyo (JP)

(73) Assignee: Dai Nippon Printing Co., Ltd., Shinjuku-ku, TOKYO (JP)

(21) Appl. No.: 13/264,697

(22) PCT Filed: Apr. 1, 2010
(86) PCT No.: PCT/JP2010/056019

§ 371 Date: Nov. 29, 2011

(30) Foreign Application Priority Data
Apr. 20, 2009 (JP) 2009-101766

(51) Int. Cl. B32B 3/00; G02B 5/02; B32B 5/16; G02B 5/22

(52) U.S. Cl. 428/144; 252/582; 252/587; 252/589

(57) ABSTRACT

The present invention provides fine particles for an optical function layer which can provide both high anti-glare properties and high black color reproducibility and give an optical function layer suitably applicable to a high definition display device. The fine particles for being added to a transparent base used in formation of an optical function layer each comprise a core, and a shell covering the core, wherein the fine particles have a mean particle size R that is larger than a wavelength of light entering the optical function layer, a ratio (r/R) of a mean core size r to the mean particle size R is 0.50 or higher, and the shell has a refractive index different from the transparent base and has light-absorbing properties.

### TECHNICAL FIELD

The present invention mainly relates to fine particles used for an optical element to be used in various display devices for display of images such as a word processor, a computer, and a television.

### BACKGROUND ART

Image display devices such as a cathode ray tube display device (CRT), a liquid crystal display device (LCD), a plasma display device (PDP), and an electroluminescence display device (ELD) generally have an optical film for antireflection, on the outermost surface thereof. Such an antireflection optical film suppresses reflection of images and decreases the reflectivity, by scattering light or interfering with light.

An anti-glare film having an anti-glare layer with surface roughness on a surface of a transparent base is known as one of such antireflection optical films. Such an anti-glare film scatters light by the surface roughness on the surface, and therefore can prevent a decrease in the visibility to be caused by reflection of light and images.

Patent Document 1, for example, teaches an anti-glare film having a surface roughness formed by particles.

In these years, image display devices such as a liquid crystal display device are required to provide higher display qualities, especially excellent black color reproducibility as well as the anti-glare properties.

Patent Document 2, for example, teaches one way of increasing the black color reproducibility as well as anti-glare properties, which is an optical film having a light diffusion layer containing at least two kinds of translucent resin particles which have mean particle sizes different from each other and have the particle sizes controlled within a predetermined range.

Those known methods, however, cannot provide both anti-glare properties and black color reproducibility at a very high level required in these years.

Meanwhile, there has been a way of using, for transmission screens and the like, an optical element of a diffusion sheet that is produced by mixing fine particles having a refractive index different from the base with a thermoplastic resin or dispersing the fine particles in a thermosetting resin. Those fine particles, however, cause backscattering of light, leading to a problem of a low contrast.

In order to prevent such a decrease in the contrast caused by fine particles, the following fine particles have been proposed, for example. That is, Patent Document 3 teaches fine particles each having on the surface thereof an antireflection layer using interference. Patent Document 4 teaches fine particles which have a refractive index gradually or continuously changing. However, the fine particles having antireflection layers tend to be colored as a result of the interference, and it is difficult to increase the scattering with the fine particles having a changing refractive index.
Patent Document 1: JP 6-18706 A
Patent Document 2: JP 2007-041547 A
Patent Document 3: JP 2005-17920 A
Patent Document 4: JP 2-120702 A

### SUMMARY OF THE INVENTION

### Problems to be Solved by the Invention

The present invention aims to provide fine particles for an optical function layer which can provide high anti-glare property, high diffusibility, and high black color reproducibility, and give an optical function layer suitably applicable to a high definition display device. The present invention also aims to provide an optical element for a display device, an anti-glare film, and a diffusion film which include the fine particles.

### Means for Solving the Problems

One aspect of the present invention is fine particles for an optical function layer, for being added to a transparent base used in formation of an optical function layer, the fine particles each comprising

a core, and

a shell covering the core,

wherein the fine particles have a mean particle size R that is larger than a wavelength of light entering the optical function layer,

a ratio (r/R) of a mean core size r to the mean particle size R is 0.50 or higher, and

the shell has a refractive index different from the transparent base and has light-absorbing property.

In the fine particles according to the present invention, in the case that a ratio (n2/n1) of a refractive index n2 of the shell to a refractive index n1 of the transparent base is Δn, then Δn and (r/R) preferably satisfy the following formulas (1) to (4):

if Δn<0.94, (r/R)>0.53 (1);

if 0.94≦Δn<1.0, (r/R)>7.2×Δn−6.1 (2);

if 1.0<Δn≦1.067, (r/R)>7.8−6.8×Δn (3);

and

if 1.067<Δn, (r/R)>0.53 (4).

It is preferable that Δn and (r/R) further satisfy the following formulas (5) and (6):

if Δn<1.0, (r/R)>1.5×Δn−0.5 (5);

and

if 1.0<Δn, (r/R)>3.2−2.2×Δn (6).

Also, it is preferable that Δn and (r/R) further satisfy the following formula (7):

if 1.0<Δn, α>1.9−0.9×Δn (7).

In the fine particles according to the present invention, the core and the shell each are preferably formed from an organic material, and

the organic material constituting the shell preferably contains an additive that has light-absorbing properties in at least one range selected from the group consisting of an ultraviolet range, a visible range, and an infrared range.

Further, in the case that a luminance of direct transmission in diffused luminance distribution is represented by p, and a luminance of direct transmission in diffused luminance distribution at a maximum absorption wavelength of the additive in particles each containing no additive with the light-absorbing properties in the shell thereof is represented by P, then

(p/P) is preferably 0.6 or higher.

Here, the additive preferably has substantially the same absorption at each wavelength in a visible range.

Another aspect of the present invention is an optical element for a display device, comprising an optical function layer that includes a transparent base and the fine particles according to the present invention,

wherein a proportion (% by mass) of the fine particles in the optical function layer is not lower than a value calculated from the following formula (8), and not higher than a value calculated from the following formula (9):

0.34×R³/T (8); and

121×R/T (9),

wherein T represents a mean thickness (μm) of the optical function layer,

R represents a mean particle size (μm) of the fine particles for an optical function layer, and

R<T.

Yet another aspect of the present invention is an anti-glare film having a rough surface formed by the fine particles according to the present invention.

Yet another aspect of the present invention is a diffusion film comprising

an optical function layer for a display device, the layer including a transparent base and the fine particles according to the present invention,

wherein the transparent base contains a thermoplastic resin and/or a thermosetting resin.

Hereinafter, the present invention is explained in detail.

The present inventors have made various studies on optical function layers in which a base (binder component) contains fine particles, and have found that light passing through the optical function layer causes stray light and backscattering when passing through the fine particles, and the stray light and backscattering inhibit improvement in the black color reproducibility of a display device.

The present inventors have made further studies based on the above knowledge, and have found the following phenomenon. That is, as illustrated in FIG. 2 and FIG. 3, light (hereinafter also referred to as “incident light” 21 (31)) which has entered a fine particle 20 (30) contained in a transparent base (not illustrated) produces reflected light (hereinafter also referred to as “internally reflected light” 22 (32)) to the internal direction of the fine particle 20 (30) in the interface between the fine particle 20 (30) and the transparent base when traveling out to the transparent base as transmitted light 23 (33). At this time, the internally reflected light 22 (32) is concentrated in a predetermined region in the fine particle 20 (30). FIG. 2 is a schematic view illustrating the directions of light travel in the case that the ratio (n2/n1) of the refractive index n2 of a shell of the fine particle to the refractive index n1 of the transparent base is less than 1. FIG. 3 is a schematic view illustrating the directions of light travel in the case that the ratio (n2/n1) of the refractive index n2 of the shell of the fine particle to the refractive index n1 of the transparent base exceeds 1. In FIGS. 2 and 3, the core and the shell in each of the fine particles 20 and 30 have the same refractive index, and light reflecting on the surfaces of the fine particles 20 and 30 are not illustrated.

The present inventors have then found as a result of further studies that occurrence of stray light can be suitably prevented if the region in the fine particle in which the internally reflected light is concentrated has light-absorbing properties. Thereby, the present invention has been completed.

That is, the light (light required) passing through the fine particle is absorbed only through the thickness of the region that has light-absorbing properties, and therefore the transmittance does not decrease much. Meanwhile, the internally reflected light to be stray light travels much longer distance in the region having light-absorbing properties than the light passing through the fine particle. This means that the internally reflected light is subjected to stronger absorbing influence in the region, and thus occurrence of stray light is suppressed.

The fine particles for an optical function layer according to the present invention are to be added to a transparent base used in formation of an optical function layer.

The optical function layer is not particularly limited, and may be a conventionally known surface film, screen, or the like to be arranged on the surface of a display device for high definition images. Examples thereof include anti-glare layers, hard coat layers, antireflection layers, antistatic layers, and diffusion layers. Particularly, anti-glare layers and diffusion layers are suitable.

The fine particles for an optical function layer according to the present invention can be used for applications other than display if the shells thereof have the later-described light-absorbing properties for a range other than the visible range. For example, the fine particles may be used to prevent stray light of infrared light used for switching with a remote controller or position detection with a pointer such that the detection accuracy is increased. Alternatively, the fine particles may be used in a diffusion plate of an ultraviolet irradiation device to prevent reflection of harmful ultraviolet light. It is also possible to limit the light wavelengths causing backscattering if the later-described additive to be contained in the shell is one that has windows at light wavelengths. Further, if a wavelength-converting material is used as the additive, the light wavelengths causing backscattering can be changed.

FIG. 1 is a cross-sectional view schematically illustrating an example of one of the fine particles for an optical function layer according to the present invention. As illustrated in FIG. 1, a fine particle 10 for an optical function layer according to the present invention has a core 11 and a shell 12 covering the core 11.

The core in each of the fine particles according to the present invention is produced from a transparent material, and is preferably produced from an organic material. Examples of the material constituting such a core include, but not particularly limited to, styrene resins (refractive index: 1.60), melamine resins (refractive index: 1.57), acrylic resins (refractive index: 1.49), acrylic-styrene copolymer resins (refractive index: 1.49 to 1.60), polycarbonate resins (refractive index: 1.59), polyethylene (refractive index: 1.53), and polyvinyl chloride (refractive index: 1.54). Among these, styrene resins and acrylic-styrene resins are suitably used, and acrylic-styrene copolymer resins are particularly suitably used because the refractive index can be easily changed when the ratio between acrylic and styrene units is changed.

The shell has a refractive index different from the transparent base, and has light-absorbing properties. In the case that the refractive index of the shell is the same as that of the transparent base, optical elements for a display device, such as an anti-glare film or diffusion film containing the fine particles according to the present invention, may not have sufficient optical properties (e.g., preventing scintillation property, diffusibility).

Examples of the shell include ones produced by adding an additive having light-absorbing properties to the organic material constituting the core.

The additive is not particularly limited but, for example, an additive that has light-absorbing properties for at least one range selected from the group consisting of an ultraviolet range, a visible range, and an infrared range is particularly suitably used. Use of an additive having such light-absorbing properties enables the fine particles according to the present invention to be suitably applied to the optical function layer. Particularly in order to increase the contrast, the additive is preferably one that has substantially the same absorption at each wavelength in a visible range. This is because if the additive has substantially the same absorption at each wavelength in a visible range, neither the image light nor the reflected light is colored in an optical function element containing the fine particles according to the present invention, such as one for a display device. The phrase “substantially the same absorption” means that the additive is neutral black or neutral gray, that is, the additive has a ratio of absorption at respective wavelengths in the visible range of ±10% or lower.

The additive is not particularly limited and may be contained in the shell as fine particles, or may be dissolved in the shell material. Here, the additive may or may not have transparency. Specifically, a known dye or pigment may be used alone or two or more of these may be used in combination as the additive, depending on the production method of the fine particles according to the present invention.

The amount of the additive(s) is appropriately adjusted to the level that enables suitable absorption of the internally reflected light and allows sufficient transmission of the light entering the fine particles according to the present invention, in view of the conditions such as the materials constituting the shell and the core and the material constituting the transparent base.

Here, if the difference in the refractive indexes of the transparent base and the fine particles is increased to improve the diffusion properties of the optical function layer produced from a transparent base containing the fine particles, a problem may arise in which surface reflection of the fine particles increases. Therefore, the shell in each of the fine particles according to the present invention preferably has a refractive index between the refractive indexes of the core and the transparent base. If the refractive index of the shell satisfies the above condition, the surface reflection can be suitably suppressed.

The fine particles according to the present invention have a mean particle size R that is larger than a wavelength of light entering the optical function layer. If the mean particle size R is smaller than the wavelength of the incident light, the optical path of the light radiated to the fine particles according to the present invention cannot be specified, and thus the transmission amount of light and the absorption amount of the stray light cannot be adjusted.

Specifically, the mean particle size R is preferably 0.4 μm to 20 μm. This is because a mean particle size R of smaller than 0.4 μm tends to be smaller than the wavelength of the incident light, which limits the light applicable to an optical function layer containing the fine particles according to the present invention. Further, an optical function layer having sufficient anti-glare properties and black color reproducibility may not be produced. In contrast, a mean particle size R exceeding 20 μm tends to cause scintillation, leading to a decrease in the qualities of the display device that employs an optical film containing the fine particles according to the present invention.

The minimum mean particle size R is more preferably 0.8 μm, and the maximum mean particle size is more preferably 10 μm in terms of increasing the contrast.

Further, a ratio (r/R) of a mean core size r to the mean particle size R in the fine particles according to the present invention is 0.50 or higher. If the ratio is lower than 0.50, the stray light is excessively absorbed by the fine particles according to the present invention, and the intensity of the transmitted light may conversely decrease, whereby an optical function layer containing such fine particles may have a lower transmittance.

In the present invention, the ratio (r/R) is preferably 0.70 or higher, and is more preferably 0.85 or higher. This is because the advantages of an increase in the absorption efficiency of the stray light outweigh the disadvantages of the decrease in the intensity of the transmitted light due to the shell.

The mean particle size R and the mean core size r can be measured by cross-sectional observation of the fine particles according to the present invention, using a known microscopic observation method.

In the case that a ratio (n2/n1) of a refractive index n2 of the shell of the fine particles of the present invention to a refractive index n1 of the transparent base is Δn (hereinafter also referred to as a specific refractive index), then Δn and (r/R) preferably satisfy the above formulas (1) to (4). The fine particles according to the present invention may have suitable transmission of incident light and show high properties of absorbing internally reflected light if the ratio (r/R) satisfies the formulas (1) to (4).

In the fine particles according to the present invention, Δn and (r/R) preferably further satisfy the above formulas (5) and (6). The fine particles according to the present invention may have more suitable transmission of incident light and show higher properties of absorbing internally reflected light if Δn and (r/R) further satisfy the formulas (5) and (6).

Further, Δn and (r/R) of the fine particles according to the present invention preferably further satisfy the above formula (7). If Δn and (r/R) further satisfy the above formula (7), the balance between the light transmission and properties of absorbing the internally reflected light in the fine particles according to the present invention becomes most suitable.

FIGS. 4, 5, and 6 are graphs each showing the relation between the core size (%) [(r/R)×100] and the specific refractive index of the fine particles according to the present invention, for each percentage of the reflectivity of absorbing the internally reflected light. As illustrated in these graphs, the reflection inside fine particles depends on the specific refractive index. FIG. 4 is a graph showing the core size (%) required to lead to the shell the internally reflected light with a reflectivity of 0.1% in the interface between the fine particle and the transparent base, based on the formulas (1) to (4). Similarly, FIG. 5 is a graph in the case that the reflectivity is 1%, based on the formulas (5) and (6). FIG. 6 is a graph in the case that the reflectivity is 10%, based on the formula (7).

That is, the scale of the absorption effect compared to the decrease in the intensity of the transmitted light is: formulas (1) to (4)<formulas (5) and (6)<formula (7).

In the fine particles according to the present invention, in the case that a luminance of direct transmission in diffused luminance distribution is represented by p, and a luminance of direct transmission in diffused luminance distribution at a maximum absorption wavelength of the additive in particles each containing no additive with the light-absorbing properties in the shell thereof is represented by P, then (p/P) is preferably 0.6 or higher.

Here, (p/P) is a parameter that indicates the light-absorption degree of the shell of each of the fine particles according to the present invention. If (p/P) is lower than 0.6, the transmittance of the light passing through the fine particles according to the present invention may be low, and thus the fine particles may be inappropriate for use in an optical function layer. The minimum value of (p/P) is more preferably 0.7, and still more preferably 0.8.

The value of (p/P) is preferably obtained through measurement of the fine particles. Still, if the fine particles are small and cannot be easily measured, the value of (p/P) can be (p′/P′) calculated by the following method.

<The Case that Shell of Fine Particle is Produced by Post-Coloring>
(1) Produce a 1-mm-thick plate by pressing the fine particles in the uncolored state.
(2) Measure the transmittance (P′) in the visible range of the produced plate.
(3) Color the plate on the same condition for forming the shell of each of the fine particles according to the present invention such that a treated plate having a colored layer of the same thickness as the shell is produced.
(4) Measure the transmittance (p′) in the visible range of the produced treated plate.
(5) Calculate (p′/P′).
   <The Case that Shell of Fine Particle is Produced by Covering Core with Dye or Pigment>
(1) Produce a 1-mm-thick plate by pressing the material of the cores of the fine particles.
(2) Measure the transmittance (P′) in the visible range of the produced plate.
(3) Measure the thickness A of the shell.
(4) Produce a core plate having a thickness of 1-2×A (mm) by pressing the material of the cores of the fine particles.
(5) Prepare a paint from the material for the shell of the fine particles according to the present invention, and coat the core plate with the paint to a total thickness of 1 mm, so that a treated plate is produced.
(6) Measure the transmittance (p′) in the visible range of the produced treated plate.
(7) Calculate (p′/P′).

Since the fine particles according to the present invention each have a core and a shell having the above structures, not much internally reflected light is produced in the fine particles dispersed in the later-described transparent base when light passes through the fine particles. Therefore, the stray light can be effectively suppressed. For this reason, an optical function layer can be produced which is capable of providing both the anti-glare properties and the black color reproducibility at a very high level, and being suitably applied to a high definition display.

The fine particles according to the present invention, each of which has such a structure with a core and a shell, can be produced by, for example, the following methods: a method of soaking fine particles, formed in advance, into a dye bath having permeability to the material of the fine particles so as to impregnate the vicinity of the surface of each fine particle with the dye; a method of causing polymerization of a dye or pigment dissolved or dispersed in a reaction liquid in the interface of the core material; a method of adding a core material to a polymer solution in which a dye or pigment is dissolved or dispersed to produce microdroplets in the dispersion, and then solidifying the microdroplets by removing the solvent; and a method of adding a core material in a liquid containing a shell material in which a dye or pigment is dissolved or dispersed, and then spraying the resulting mixture into hot air.

The transparent base to which the fine particles according to the present invention are added serves as a binder component of the fine particles.

Such a transparent base is not particularly limited as long as it is transparent and can have fine particles dispersed therein, and examples thereof include ionizing radiation-curable resins curable by ultraviolet rays or electron rays, solvent-drying resins, thermoplastic resins, and thermosetting resins.

For example, consider the cases that the fine particles according to the present invention are used in production of a surface film such as an anti-glare film and a hard coat film, that a transmission screen or the like is to be produced from an ionizing radiation-curable resin containing the fine particles according to the present invention, and that a dispersion film or the like is to be produced from a thermoplastic resin containing the fine particles according to the present invention. In those cases, a thermoplastic resin and/or a thermosetting resin can be used in the forms appropriate for various processes such as ultraviolet curing, extrusion molding, and silk printing. Here, the transparent base used for producing the above surface film, transmission screen, and diffusion film is not limited to the above ones. Here, the term “resin” includes resin compositions such as a monomer, and an oligomer, and a polymer.

Examples of the ionizing-radiation curing resin include compounds having one or two or more unsaturated bonds, such as a compound having a (meth)acrylate functional group.

Examples of the compound having one unsaturated bond include ethyl(meth)acrylate, ethylhexyl(meth)acrylate, styrene, methylstyrene, and N-vinyl pyrrolidone. Examples of the compound having two or more unsaturated bonds include reaction products of (meth)acrylate or the like with a multifunctional compound (for example, poly(meth)acrylate esters of polyhydric alcohols) such as polymethylolpropane tri(meth)acrylate, hexanediol(meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and neopentylglycol di(meth)acrylate. The term “(meth)acrylate” used herein refers to methacrylate and acrylate.

In addition to the above compounds, resins having an unsaturated double bond and a comparatively low molecular weight, such as a polyester resin, a polyether resin, an acrylic resin, an epoxy resin, a urethane resin, an alkyd resin, a spiroacetal resin, a polybutadiene resin, and a polythiol polyene resin, can be used as the above ionizing-radiation curable resin.

The transparent base is preferably produced from an ultraviolet-curable resin in the case that the fine particles for an optical function layer according to the present invention are used for a surface film.

In the case that the ionizing radiation-curable resin is used as the above ultraviolet-curable resin, the composition for forming the optical function layer preferably contains a photopolymerization initiator.

Specific examples of the photopolymerization initiator include acetophenones, benzophenones, Michler's benzoyl benzoate, α-amyloxime esters, thioxanthones, propiophenones, benzyls, benzoins, and acyl phosphine oxides. Also, the composition preferably further contains a photosensitizer, and specific examples thereof include n-butylamine, triethylamine, and poly-n-butyl phosphine.

In the case that the ionizing-radiation curable resin is a resinous one having a radically polymerizable unsaturated group, one of acetophenones, benzophenones, thioxanthones, benzoins, and benzoin methyl ether, or any combination of these is preferably used as the photopolymerization initiator. Alternatively, in the case that the ionizing radiation-curable resin is a resinous one having a cationically polymerizable functional group, one of aromatic diazonium salts, aromatic sulfonium salts, aromatic iodonium salts, metallocene compounds, and benzoin sulfonic esters, or any combination of these may be used as the photopolymerization initiator.

The addition amount of the photopolymerization initiator is preferably 0.1 to 10 parts by mass for each 100 parts by mass of the ionizing radiation-curable resin.

The ionizing-radiation curable resin can be used in combination with a solvent-drying resin.

A major example of the solvent-drying resin may be a thermoplastic resin. The thermoplastic resin may be one included in the typical examples thereof. Addition of the solvent-drying resin enables to effectively prevent a coating-film defect on the coated surface.

Specific examples of preferable thermoplastic resins include styrene resins, (meth)acrylic resins, vinyl acetate resins, vinyl ether resins, halogen-containing resins, alicyclic olefin resins, polycarbonate resins, polyester resins, polyamide resins, cellulose derivatives, silicone resins, rubbers, and elastomers.

Usually, the thermoplastic resin is preferably a resin that is amorphous and soluble in an organic solvent (particularly a common solvent which can dissolve polymers and curable compounds). Particularly, resins having high moldability, film-forming properties, transparency, and weatherability, such as styrene resins, (meth)acrylic resins, alicyclic olefin resins, polyester resins, and cellulose derivatives (such as cellulose esters) are preferable.

In the case that the material of the light-transmitting substrate to have the optical function layer laminated thereon is a cellulose resin such as triacetyl cellulose “TAC”, specific preferable examples of the thermoplastic resin include cellulose resins such as nitrocellulose, acetylcellulose, cellulose acetate propionate, and ethyl hydroxyethyl cellulose. Use of the cellulose resin in the optical function layer enables to increase the transparency and the adhesion to the light-transmitting substrate.

Examples of the thermosetting resin include phenol resins, urea resins, diallyl phthalate resins, melamine resins, guanamine resins, unsaturated polyester resins, polyurethane resins, epoxy resins, amino alkyd resins, melamine-urea co-condensation resins, silicon resins, and polysiloxane resins. In the case of using the thermosetting resin, a curing agent such as a crosslinking agent and a polymerization initiator, a polymerization promoter, a solvent, and a viscosity-controlling agent can also be used together as needed.

With the transparent base and the fine particles for an optical function layer according to the present invention, an optical element for a display device which includes an optical function layer can be formed.

Such an optical element for a display device is also one aspect of the present invention.

That is, the optical element for a display device according to the present invention comprises an optical function layer that includes a transparent base and the fine particles according to the present invention,

wherein a proportion (% by mass) of the fine particles in the optical function layer is not lower than a value calculated from the following formula (8), and not higher than a value calculated from the following formula (9):

0.34×R³/T (8); and

121×R/T (9),

wherein T represents a mean thickness (μm) of the optical function layer,

R represents a mean particle size (μm) of the fine particles for an optical function layer, and

R<T.

The optical element according to the present invention is provided with an optical function layer including the transparent base and the fine particles according to the present invention.

Examples of the transparent base of the optical function layer include the ones described for the fine particles according to the present invention.

In the optical function layer, the following conditions are satisfied if the mean thickness is represented by T (μm) and the mean particle size of the fine particles for an optical function layer is represented by R (μm): R<T; and the proportion (%) of the fine particles in the optical function layer is not lower than a value calculated from the formula (8), and not higher than a value calculated from the formula (9).

The formula (8) indicates that the distance between the fine particles in the optical function layer is not longer than the highest naked-eye resolution of 35 μm by the vision of 2 at a clear vision distance of 25 cm. Hence, if the proportion of the fine particles is lower than the value calculated from the formula (8), the fine particles contained in the optical function layer observed with the naked eye may be observed as particles separated from each other, and those separated fine particles may seem like foreign matters.

Meanwhile, the formula (9) indicates that the fine particles in the optical function layer are in the closest packing. Accordingly, if the proportion of the fine particles is higher than the value calculated from the formula (9), some of the fine particles may be projected from the optical function layer, and thus such parts where the fine particles are concentrated may be recognized as black foreign matters.

The “proportion of the fine particles for an optical function layer” is represented by % by weight of the fine particles relative to the weight of the transparent base and the fine particles in the optical function layer.

Examples of the method of forming such an optical function layer include a method using a coating solution that is produced by mixing a solvent, the transparent base, the fine particles and, according to need, various additives such as a leveling agent, an antistatic agent, and a stain proofing agent. That is, the optical function layer can be formed by applying the coating solution on a predetermined base film to form a coating film, and then curing the coating film.

Examples of the solvent include, but not particularly limited to, alcohols such as isopropyl alcohol, methanol and ethanol; ketones such as methyl ethyl ketone, methyl isobutyl ketone, and cyclohexanone; esters such as methyl acetate, ethyl acetate, and butyl acetate; halogenated hydrocarbons; aromatic hydrocarbons such as toluene and xylene; propylene glycol monomethyl ether (PGME); and mixtures thereof. Among these, ketones and esters are preferable.

The base film is not particularly limited, and may be produced from a material selected from ones having higher transparency than common plastics. Examples thereof include extended or unextended films produced from a material such as polyethylene terephthalate, polybutylene terephthalate, polyamide (Nylon 6, Nylon 66), triacetyl cellulose, polystyrene, polyarylate, polycarbonate, polyvinyl chloride, polymethylpentene, polyethersulfone, and polymethyl methacrylate. Each of these films can be used alone, or two or more films may be used as a multi-layer film.

The thickness of the base film is preferably about 10 μm to 200 μm. A base film having a thickness of smaller than 10 μm may have insufficient strength, not being able to sufficiently support the optical function layer. A base film having a thickness exceeding 200 μm, in contrast, may lead to waste of resources and may be difficult to handle at the time of processing.

The method of applying a coating solution to form a coating film is not particularly limited, and examples thereof include a method of applying 3 g/m² to 15 g/m² (solid equivalent, hereinafter represented in the same manner) of a coating solution using a commonly used technique such as reverse roll coating, roll coating, Meyer bar coating, and gravure coating.

Examples of the method of curing a coating film include a method of irradiating the coating film with electromagnetic waves such as electron rays, ultraviolet rays, and visible rays. The curing by the ultraviolet rays can be performed using electromagnetic waves emitted from an ultra-high-pressure mercury lamp, a high-pressure mercury lamp, a carbon arc, a xenon arc, a metal-halide lamp, or the like.

The curing reaction by such ionizing radiation is preferably caused in atmosphere with as low oxygen concentration as possible. Under low oxygen atmosphere, the curing reaction can be completed without curing inhibition by oxygen, or coloring or decomposition by a secondary reaction other than the desired polymerization reaction. Therefore, the optical function layer can maintain abrasion resistance that enables excellent retention of the added fine particles. In contrast, in the case that the oxygen concentration is high, the curing reaction may not be completed, and the optical function layer may have low abrasion resistance which may lead to coming off of the fine particles. Here, the oxygen concentration is preferably 1000 ppm or lower.

If the optical function layer to be formed as above has a surface with irregularities formed by the fine particles according to the present invention (hereinafter, such a layer is referred to as an anti-glare layer), the optical element for a display device can be used as an anti-glare film.

Such an anti-glare film is also one aspect of the present invention.

Since the anti-glare film of the present invention has, on the surface of the anti-glare layer thereof, irregularities formed by the fine particles according to the present invention, stray light is hardly caused which is attributed to the light entering the fine particles and being internally reflected in the fine particles. Hence, the anti-glare film has excellent anti-glare properties and black color reproducibility.

That is, the anti-glare film of the present invention can be provided with excellent transmission image clarity and anti-image reflection properties.

In order to reinforce and stabilize the adhesion between the base film and the anti-glare layer in the anti-glare film of the present invention, the coating surface of the base film is preferably subjected to surface treatment using corona discharge or ozone gas, or is preferably provided with a primer layer produced from a material that is compatible with the surfaces of both base film and anti-glare layer and provides high adhesion. The primer layer can be formed by applying a reactive varnish produced from polyisocyanate and polyester polyol or polyether polyol.

### Effect of the Invention

The fine particles for an optical function layer according to the present invention which have the above structure, when contained in the transparent base, can suitably absorb the internally reflected light of the light passing therethrough. The optical function layer containing the fine particles according to the present invention can provide anti-glare properties and black color reproducibility at a very high level, and is suitably applicable to a high definition display device.

### BRIEF DESCRIPTION OF DRAWINGS

FIG. 1 is a cross-sectional view schematically illustrating one example of the fine particles for an optical function layer according to the present invention;

FIG. 2 is a schematic view illustrating the directions of light travel in the case that the ratio (n2/n1) of the refractive index n2 of a fine particle to the refractive index n1 of a transparent base is less than 1;

FIG. 3 is a schematic view illustrating the directions of light travel in the case that the ratio (n2/n1) of the refractive index n2 of the fine particle to the refractive index n1 of the transparent base exceeds 1;

FIG. 4 is a graph showing the relation between (r/R) and Δn in the fine particles according to the present invention in the case that the fine particles absorb internally reflected light up to an internal reflectivity of 0.1%;

FIG. 5 is a graph showing the relation between (r/R) and Δn in the fine particles according to the present invention in the case that the fine particles absorb internally reflected light up to an internal reflectivity of 1%; and

FIG. 6 is a graph showing the relation between (r/R) and Δn in the fine particles according to the present invention in the case that the fine particles absorb internally reflected light up to an internal reflectivity of 10%.

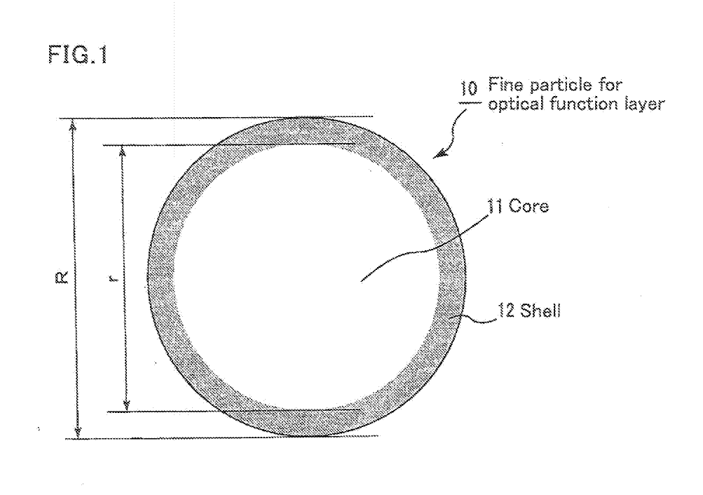

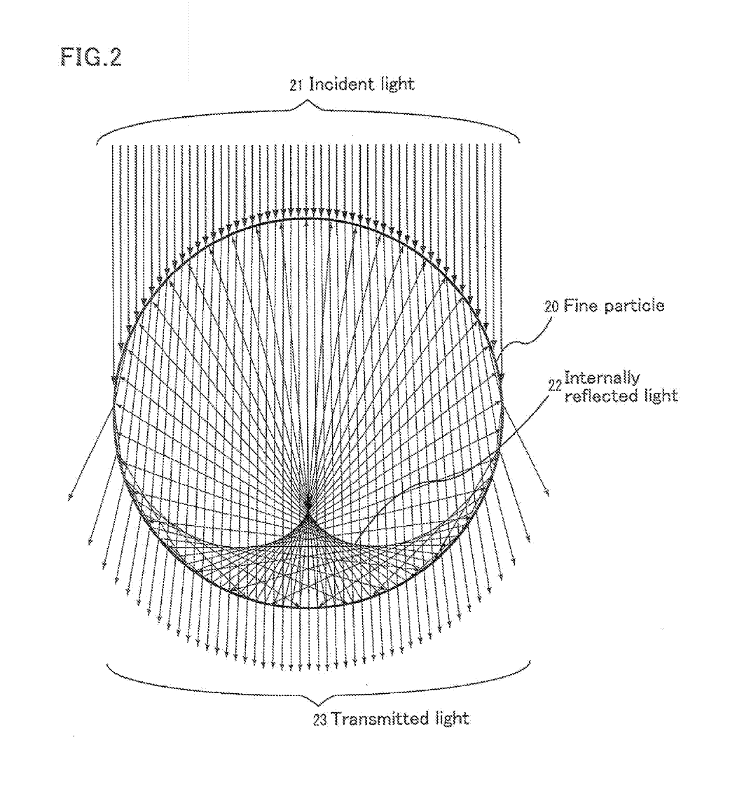

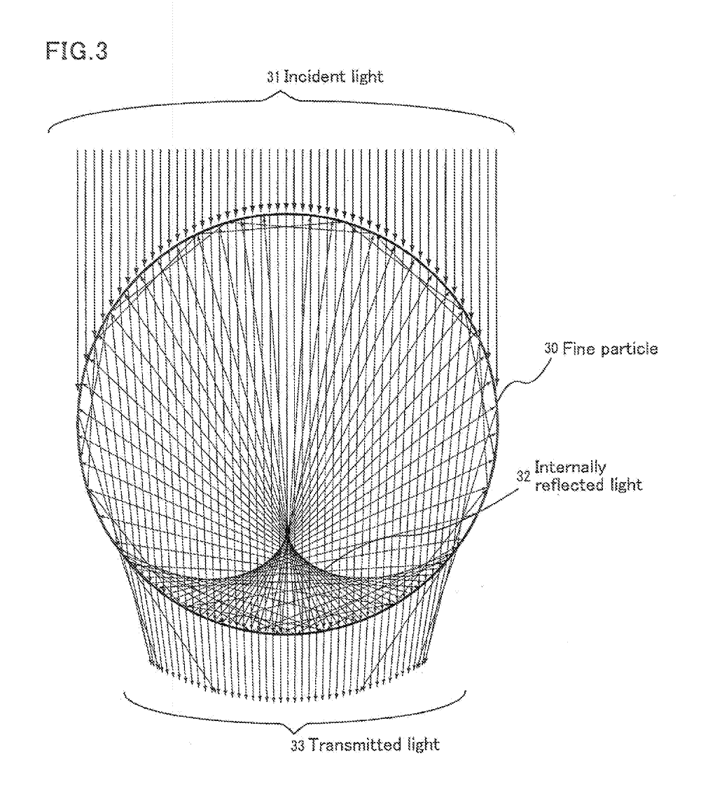

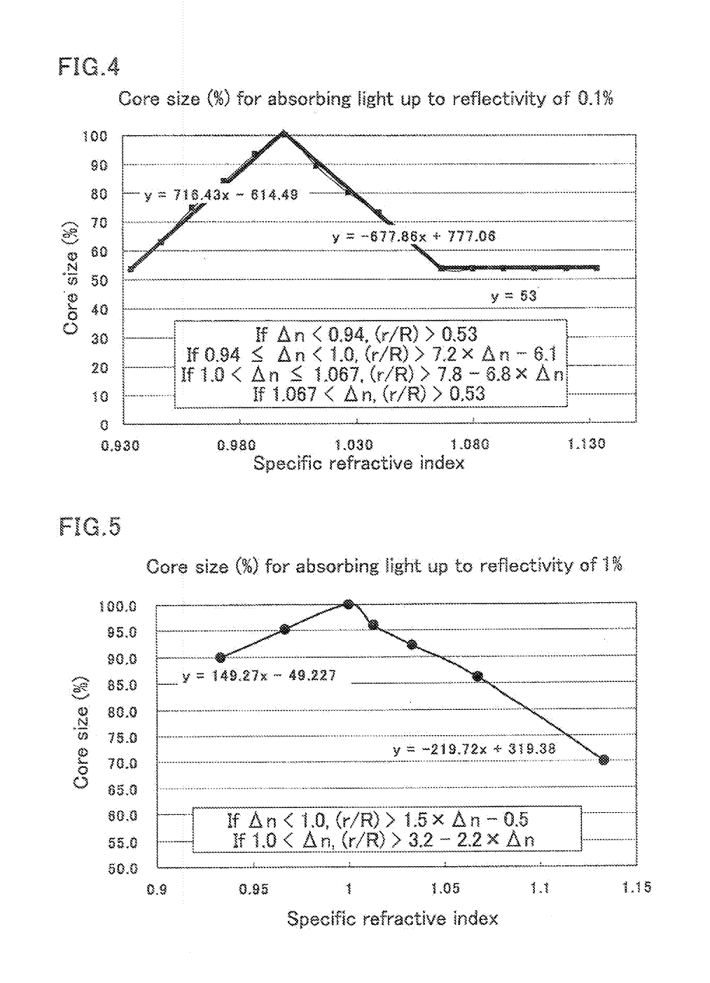

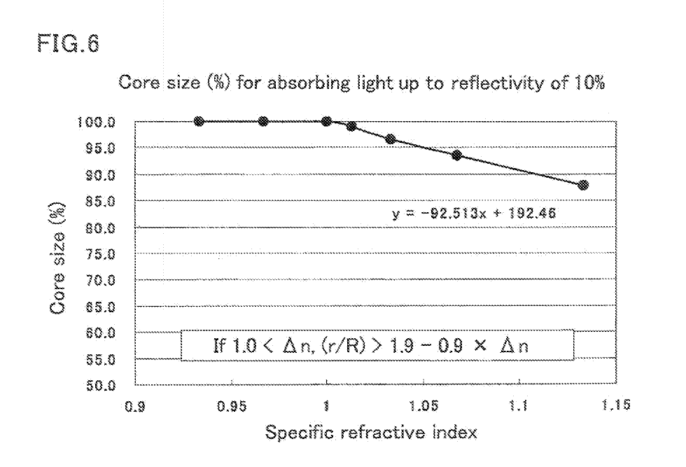

### MODES FOR CARRYING OUT THE INVENTION

The present invention will be described by means of the following Examples which, however, are not intended to limit the scope of the present invention. Here, “part(s)” and “%” are based on mass unless otherwise stated.

### EXAMPLE 1

First, 90 parts of styrene and 10 parts of methyl methacrylate were emulsion-copolymerized to obtain monodisperse particles of a styrene-acrylic copolymer. The mean particle size R of the monodisperse particles was 3.5 μm, and the refractive index was 1.58.

Next, 5 g of the obtained monodisperse particles were added at 60° C. to a dye solution prepared by diluting 20 g of SDN black (dye for resin) produced by SAWADA PLATEC CO., LTD. by 1000 g of water. The resulting solution was stirred for one minute so that the fine particles were colored and the shells were formed. The fine particles were then rinsed and dried, and thereby fine particles for an optical function layer were obtained.

The cross-sections of the obtained fine particles for an optical function layer were observed with a microscope. The fine particles had a ratio (r/R) of the mean core size r to the mean particle size R of 0.91 (shell thickness: 0.16 μm), and a refractive index of the shell of 1.58.

Here, 1-mm-thick plates were obtained by pressing the monodisperse particles, and one of the plates was treated with the above dye solution under the same condition so that a treated plate was produced. The ratio of transmission in the visible range of the treated plate to the untreated plate was 0.85. The thickness of the colored layer of the above plate was the same as that of the above shell, and therefore the absorption index of the fine particles was determined as 0.15.

Then, 6 parts of the fine particles were added to a precursor (post-curing refractive index: 1.50) of a transparent base containing 45 parts of pentaerythritol triacrylate, 2 parts of IRGACURE 184 (brand name), 35 parts of toluene, and 15 parts of cyclohexane. Thereby, a coating solution for forming an anti-glare layer was prepared.

The obtained coating solution was applied on one face of an 80-μm-thick triacetyl cellulose film by a bar coater, and then dried under the condition of one minute at 50° C. Then, the dried solution was cured by a UV irradiation device [H bulb (brand name), product of Fusion UV Systems Japan KK] with a cumulative luminous energy of 100 mj at an oxygen concentration maintained to 0.1% or lower, so that an anti-glare layer having a film thickness of about 5 μm was obtained. Thereby, an anti-glare film was produced.

### EXAMPLE 2

Fine particles for an optical function layer were produced by the same procedure as that for Example 1, except that the amount of the dye in the dye solution was 10 g and the coloring condition was two minutes at 65° C. The fine particles had r/R of 0.75 (shell thickness: 0.44 μm), a refractive index of the shell of 1.58, and an absorption index of 0.28.

Using the obtained fine particles, an anti-glare film was obtained by the same procedure as that for Example 1.

### EXAMPLE 3

Fine particles for an optical function layer were produced by the same procedure as that for Example 1, except that the amount of the dye in the dye solution was 5 g and the coloring condition was three minutes at 68° C. The fine particles had r/R of 0.61 (shell thickness: 0.68 μm), a refractive index of the shell of 1.58, and an absorption index of 0.39.

Using the obtained fine particles, an anti-glare film was obtained by the same procedure as that for Example 1.

### COMPARATIVE EXAMPLE 1

Monodisperse particles were produced by the same procedure as that for Example 1, but the particles were not colored. Then, an anti-glare film was produced by the same procedure as that for Example 1 using the obtained monodisperse particles.

### COMPARATIVE EXAMPLE 2

Monodisperse particles of a styrene-acrylic copolymer were obtained by emulsion-copolymerizing 10 parts of styrene and 90 parts of methylmethacrylate. The monodisperse particles had a mean particle size of 3.5 μm, and a refractive index of 1.50.

An anti-glare film was obtained by the same procedure as that for Example 1, except that these obtained monodisperse particles were used.

### COMPARATIVE EXAMPLE 3

An amount of 90 parts of styrene and 10 parts of methyl methacrylate were emulsion copolymerized under a condition different from that of Example 1, and thereby monodisperse particles of a styrene-acrylic copolymer were obtained.

The monodisperse particles according to Comparative Example 3 had a mean particle size of 0.38 μm, and a refractive index of 1.58.

An anti-glare film was obtained by the same procedure as that for Example 1, except that these obtained monodisperse particles were used.

### COMPARATIVE EXAMPLE 4

Fine particles for an optical function layer were produced by the same procedure as that for Example 1, except that the monodisperse particles of Comparative Example 2 were used, the amount of the dye in the dye solution was 10 g, and the coloring condition was two minutes at 65° C. The fine particles had r/R of 0.75 (shell thickness: 0.44 μm), a refractive index of the shell of 1.50, and an absorption index of 0.28.

An anti-glare film was obtained by the same procedure as that for Example 1, except that these obtained fine particles for an optical function layer.

### COMPARATIVE EXAMPLE 5

Fine particles for an optical function layer were produced by the same procedure as that for Example 1 using the monodisperse particles of Example 1, except that the amount of the dye in the dye solution was 10 g and the coloring condition was 5 minutes at 62° C. The fine particles had r/R of 0.43 (shell thickness: 1.00 μm), a refractive index of the shell of 1.58, and an absorption index of 0.37.

An anti-glare film was obtained by the same procedure as that for Example 1, except that these obtained fine particles were used.

### (Evaluation)

The anti-glare films obtained in Examples and Comparative Examples were evaluated using the following criteria.

Table 1 shows the results.

### <Black Level, White Level, Contrast, Scintillation, Anti-Glare Properties>

The polarizer on the outermost surface of a liquid crystal television KDL-40X2500 produced by Sony Corporation was removed, and a polarizer having no coating on the surface thereof was placed instead. Subsequently, each of the anti-glare films of Examples and Comparative Examples was attached with a transparent adhesive film to the polarizer in such a manner that the optical function layer was on the observer side.

In a 1000-Lx room, 15 subjects watched the DVD “Phantom of the Opera” produced by Media Factory Inc. on the television. The anti-glare film was evaluated as “++” in the case that 10 or more subjects determined that the black level, white level, contrast, scintillation, and anti-glare properties were good. The film was evaluated as “+” in the case of 5 to 9 subjects, and “−” in the case of 4 or less subjects.

### <Diffusibility>

The image qualities were evaluated from a position slightly off to the left or right under the same condition as that for the evaluation of the above properties such as the black level. The anti-glare film was evaluated as “++” in the case that 10 or more subjects felt that the image qualities are fine with them, “+” in the case of 5 to 9 subjects, and “−” in the case of 4 or less subjects.

TABLE 1

| | Black | White | | Scintil- | Anti-glare | Diffus- |
|---|---|---|---|---|---|---|
| | level | level | Contrast | lation | properties | ibility |
| Example 1 | ++ | ++ | ++ | ++ | ++ | ++ |
| Example 2 | ++ | ++ | ++ | ++ | ++ | ++ |
| Example 3 | ++ | ++ | ++ | ++ | ++ | ++ |
| Comparative | − | ++ | − | ++ | ++ | ++ |
| Example 1 | | | | | | |
| Comparative | + | ++ | + | − | + | − |
| Example 2 | | | | | | |
| Comparative | − | ++ | − | + | − | + |
| Example 3 | | | | | | |
| Comparative | ++ | ++ | ++ | − | + | − |
| Example 4 | | | | | | |
| Comparative | ++ | − | − | ++ | ++ | ++ |
| Example 5 | | | | | | |

As shown in Table 1, the anti-glare films according to the Examples received favorable evaluations on all the properties.

In contrast, the anti-glare film according to Comparative Example 1 which contained the fine particles having no shell received unfavorable evaluations on the black level and the contrast.

The anti-glare film according to Comparative Example 2 contained the fine particles for an optical function layer which had no shell and the same refractive index for the transparent base. The anti-glare film received unfavorable evaluations on the scintillation and diffusibility.

The anti-glare film according to Comparative Example 3 contained the fine particles for an optical function layer which had a smaller mean particle size than the wavelength (400 to 800 nm) of the light that entered the anti-glare film. The anti-glare film received unfavorable evaluations on the black level, contrast, and anti-glare properties.

The anti-glare film in Comparative Example 4 contained the fine particles for an optical function layer which had shell with the same refractive index as the transparent base. The anti-glare film received unfavorable evaluations on the glare and diffusibility.

The anti-glare film in Comparative Example 5, which contained the fine particles having a shell and r/R of not higher than 0.5, received unfavorable evaluations on the white level and contrast.

### INDUSTRIAL APPLICABILITY

The fine particles for an optical function layer according to the present invention can be suitably used for a an anti-glare layer of a display device such as a cathode ray tube display device (CRT), a liquid crystal display device (LCD), a plasma display device (PDP), and an electroluminescence display device (ELD). Particularly, the fine particles can be suitably used for an optical function layer of a high definition display device.

### EXPLANATION OF SYMBOLS

10 Fine particle for optical function layer
11 Core
12 Shell
20, 30 Fine particle
21, 31 Incident light
22, 32 Internally reflected light
23, 33 Transmitted light

1. Fine particles for an optical function layer, for being added to a transparent base used in formation of an optical function layer, the fine particles each comprising
a core, and
a shell covering the core,
wherein the fine particles have a mean particle size R that is larger than a wavelength of light entering the optical function layer,
a ratio (r/R) of a mean core size r to the mean particle size R is 0.50 or higher, and
the shell has a refractive index different from the transparent base and has light-absorbing property.

2. The fine particles according to claim 1,
wherein in the case that a ratio (n2/n1) of a refractive index n2 of the shell to a refractive index n1 of the transparent base is Δn, then Δn and (r/R) satisfy the following formulas (1) to (4):
if Δn<0.94, (r/R)>0.53 (1);
if 0.94≦Δn<1.0, (r/R)>7.2×Δn−6.1 (2);
if 1.0<Δn≦1.067, (r/R)>7.8−6.8×Δn (3); and
if 1.067<Δn, (r/R)>0.53 (4).

3. The fine particles according to claim 2,
wherein Δn and (r/R) further satisfy the following formulas (5) and (6):
if Δn<1.0, (r/R)>1.5×Δn−0.5 (5); and
if 1.0<Δn, (r/R)>3.2−2.2×Δn (6).

4. The fine particles according to claim 2,
wherein Δn and (r/R) further satisfy the following formula (7):
if 1.0<Δn, (r/R)>1.9−0.9×Δn (7).

5. The fine particles according to claim 1,
wherein the core and the shell each are formed from an organic material, and
the organic material constituting the shell contains an additive that has a light-absorbing property in at least one range selected from the group consisting of an ultraviolet range, a visible range, and an infrared range.

6. The fine particles according to claim 5,
wherein in the case that a luminance of direct transmission in diffused luminance distribution is represented by p, and a luminance of direct transmission in diffused luminance distribution at a maximum absorption wavelength of the additive in particles each containing no additive with the light-absorbing property in the shell thereof is represented by P, then
(p/P) is 0.6 or higher.

7. The fine particles according to claim 5,
wherein the additive has substantially the same absorption at each wavelength in a visible range.

8. The fine particles according to claim 1,
wherein the transparent base is produced from an ultraviolet-curable resin.

9. An optical element for a display device, comprising
an optical function layer that includes a transparent base and the fine particles according to claim 1,
wherein a proportion (% by mass) of the fine particles in the optical function layer is not lower than a value calculated from the following formula (8), and not higher than a value calculated from the following formula (9):
0.34×R³/T (8); and
121×R/T (9),
wherein T represents a mean thickness (μm) of the optical function layer,
R represents a mean particle size (μm) of the fine particles for an optical function layer, and
R<T.

10. An anti-glare film having a rough surface formed by the fine particles according to claim 1.

11. A diffusion film comprising
an optical function layer for a display device, the layer including a transparent base and the fine particles according to claim 1,
wherein the transparent base contains a thermoplastic resin and/or a thermosetting resin.

12. The fine particles according to claim 3,
wherein Δn and (r/R) further satisfy the following formula (7):
if 1.0<Δn, (r/R)>1.9−0.9×Δn (7).

13. The fine particles according to claim 2,
wherein the core and the shell each are formed from an organic material, and
the organic material constituting the shell contains an additive that has a light-absorbing property in at least one range selected from the group consisting of an ultraviolet range, a visible range, and an infrared range.

14. The fine particles according to claim 3,
wherein the core and the shell each are formed from an organic material, and
the organic material constituting the shell contains an additive that has a light-absorbing property in at least one range selected from the group consisting of an ultraviolet range, a visible range, and an infrared range.

15. The fine particles according to claim 4,
wherein the core and the shell each are formed from an organic material, and
the organic material constituting the shell contains an additive that has a light-absorbing property in at least one range selected from the group consisting of an ultraviolet range, a visible range, and an infrared range.

16. The fine particles according to claim 6,
wherein the additive has substantially the same absorption at each wavelength in a visible range.

17. The fine particles according to claim 2,
wherein the transparent base is produced from an ultraviolet-curable resin.

18. The fine particles according to claim 3,
wherein the transparent base is produced from an ultraviolet-curable resin.

19. The fine particles according to claim 4,
wherein the transparent base is produced from an ultraviolet-curable resin.

20. The fine particles according to claim 5,
wherein the transparent base is produced from an ultraviolet-curable resin.
